(19) United States
(12) Patent Application Publication
(10) Pub. No.: US 2017/0185722 A1
(43) Pub. Date: Jun. 29, 2017

(54) GRAPHICAL HANDWRITING SIGN-IN METHOD AND SYSTEM

(71) Applicants: KHUE NGOC VU, Fountain Valley, CA (US); DUNG TIEN VU, Fountain Valley, CA (US); THU MINH VU, Fountain Valley, CA (US); TRUONG MIEN VU, Fountain Valley, CA (US); HIEU NGOC VU, Fountain Valley, CA (US)

(72) Inventors: KHUE NGOC VU, Fountain Valley, CA (US); Dung Tien Vu, Fountain Valley, CA (US); Thu Minh Vu, Fountain Valley, CA (US); Truong Mien Vu, Fountain Valley, CA (US); Hieu Ngoc Vu, Fountain Valley, CA (US)

(21) Appl. No.: 15/190,117

(22) Filed: Jun. 22, 2016

Related U.S. Application Data
(60) Provisional application No. 62/387,288, filed on Dec. 23, 2015.

(51) Int. Cl. G06F 19/00; H04L 29/06; G06K 9/18; G06F 3/0488; G06K 9/00

(52) U.S. Cl. CPC G06F 19/328; G06F 3/04883; G06K 9/00422; G06K 9/18; G06K 9/00161; H04L 63/08

(57) ABSTRACT

A computer network system and method of receiving, storing, and authenticating a user's presence and information obtained at geographical user-location is disclosed. A first device displays a plurality of input regions on its display screen. Utilizing a stylus or fingertip, the user enters hand-written inputs in those regions. The first device transmits the user hand-written inputs and geographical location to a server and subsequently removes the displayed plurality of hand-written inputs from the plurality of input regions for the next user. A server receives the user's hand-written inputs and location, associates the location to the user, stores them, and transmits them to a second device where, in real time, they are displayed on a display screen of the second device, facilitating authentication and verification of the user's presence and user's hand-written inputs. In addition, authenticating documents comprising the hand-written inputs may be generated for audits.

### CROSS REFERENCE TO RELATED APPLICATIONS

The present patent application is a formalization of a previously filed co-pending provisional patent application entitled “Graphical Handwriting Sign-In Method and System,” filed Dec. 23, 2015, as U.S. patent application Ser. No. 62/387,288 by the inventor(s) named in this application. This patent application claims the benefit of the filing date of the cited provisional patent application according to the statutes and rules governing provisional patent applications, particularly 35 USC §119 and 37 CFR §1.78. The specification and drawings of the cited provisional patent application are specifically incorporated herein by reference.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to a method and system for receiving, storing, and authenticating presence and user information obtained within a geographical user-location. In particular, a computer network system, includes a first device, a server, and a second device. A user inputs his/her hand-written personal information, including signature, onto the first device using a stylus or his/her fingertip. The user-location is also received and forwarded to a server where the hand-written inputs are associated with the user's location. The method facilitates authentication and verification of the information and presence of the user at the geographical user-location.

This invention may use a tablet as a standalone device, instead of the first device in the system, for receiving, storing, and authenticating presence and user information obtained within a geographical, user location. In particular, the tablet device in which a user inputs his/her handwritten personal information, including signature, using a stylus or his/her fingertip. The user location is also received where the handwritten inputs are associated with the user's location. The method facilitates authentication and verification of the information and presence of the user at the geographical user-location.

### BACKGROUND

The present invention seeks to provide a system and method of operation for receiving, storing and authenticating patience presence and personal/private information. The process is compliant with HIPPA (Health Insurance Portability and Accountability Act) and further provides an effective means to combat healthcare fraud and abuse.

Under HIPPA, certain procedures provide for maintaining the privacy and security of an individual's identifiable health information. HIPPA also provides programs and guidelines to control fraud and abuse within the healthcare system. It encourages healthcare providers to increase the efficiency of the healthcare system by creating standards for the use and dissemination of healthcare information.

The present invention is a method which is implemented on a computer network system for receiving, storing, and authenticating a user's presence and information obtained at a geographical user-location. User's hand-written biometric signal is used to identify and authenticate the user, and geographical location of the user is used to verify the user's presence at the location where the biometric signal is obtained. The hand-written biometric signal is dynamic in that it is captured in real time as the user enters his/her hand-written inputs onto a device capable of capturing and digitizing the hand-written biometric signal in real time.

A first device, such as the Apple's iPad or Android Tablet, includes a graphical user interface, commonly referred to as an APP (Application Software) which displays a number of input regions on its display screen. Utilizing a stylus or fingertip, the user enters hand-written inputs in those regions. The first device also receives the user's geographical location where the user inputs his/her hand-written inputs. The first device transmits the user hand-written inputs and geographical location to a server and subsequently removes the displayed plurality of hand-written inputs from the plurality of input regions for the next user to use. A server receives the user's hand-written inputs and location, associates the location to the user, stores them, and transmits them to a second device where, in real time, they are displayed on a display screen of the second device, facilitating authentication and verification of the user's presence and user's hand-written inputs. In addition, authenticating documents comprising the hand-written inputs may be generated from the stored data on the storage device of the server for future audits.

Although various systems have been proposed which touch upon some aspects of the above problems, they do not provide solutions to the existing limitations in providing a computer network system and method for receiving, storing, and authenticating a user's presence and information obtained at a geographical user-location. For example, U.S. Pat. App. No. 20060007189 to Gaines III, et al. entitled “Forms-based computer interface” discloses a forms-based computer interface and method which captures and interprets handwriting, pen movements, and other manual graphical-type user input for use in computerized applications and databases. An embodiment employs a portable Input and Control Device, a writing implement, and a host computing device that together capture, interpret, utilize, and store the handwriting, marks, and other pen movements of a user on and around predefined and identified forms. The Input and Control Device comprises a device for holding the predefined and identified forms and an e-clipboard for docking the holding device, capturing user input, and transmitting it to the host computing device for processing. Form, field, and user-specific handwriting and mark recognition are used in the interpretation of user input. An edit utility permits review and editing of the captured and interpreted input, permitting correction of capture and interpretation errors.

U.S. Pat. App. No. US20030214540 to Huapaya et al., entitled “Written Anywhere Tool” discloses a transparent graphical user interface that overlays the user interfaces of other applications. The transparent user interface receives handwriting input and displays handwriting objects represented by handwriting input received in the area of the transparent handwriting interface. The transparent user interface of the invention can be expanded to include most of the display area of a computer, thereby allowing the user to write anywhere within the display area. This also allows the user to write multiple lines of text. Additionally, because the user interface is transparent, it allows the user to see the underlying graphical user interfaces for other applications, including applications that receive text recognized from the handwriting input written into the transparent handwriting interface. Further the transparent interface allows the user to interact with underlying graphical user interfaces.

U.S. Pat. No. 8,928,632, to Cohen et al. entitled “Handwriting regions keyed to a data receptor” discloses embodiments which include an article of manufacture, apparatus, device, system, computer-program product, and method. In an embodiment, an article of manufacture includes a writing surface having at least two regions that accept handwriting. Each region of the at least two regions that accept handwriting respectively includes a unique user-understandable identifier and a unique machine-distinguishable identifier keyed to a data receptor.”

However, none of the above references disclose a method and a computer network system for receiving, storing, and authenticating a user's presence and information obtained at a geographical user-location.

### SUMMARY

In one aspect, a method of receiving, storing, and authenticating presence and user information obtained within a geographical user-location is disclosed. The method comprises displaying a plurality of input regions on a screen of a first device, via the first device, receiving a plurality of hand-written inputs from a user, via the first device, said user utilizing a stylus or a fingertip to input the plurality of hand-written inputs in the plurality of input regions, receiving the geographical user-location, via the first device, transmitting the plurality of hand-written inputs and the geographical user-location, via the first device, removing the displayed plurality of hand-written inputs from the plurality of input regions, via the first device, and receiving the plurality of hand-written inputs and the geographical user-location, via a server, storing the plurality of hand-written inputs and the geographical user-location, via the server, associating the geographical user-location with the plurality of hand-written inputs from the user, via the server, transmitting the plurality of hand-written inputs and the geographical user-location associated with the user, via the server, receiving the plurality of hand-written inputs and the geographical user-location associated with the user, via a second device, and in real time, consecutively displaying the plurality of hand-written inputs and the geographical user-location associated with the user on a screen of the second device, via the second device, wherein the plurality of hand-written inputs, so associated with the user, may be utilized to authenticate that the plurality of the hand-written inputs were inputted by the user and to verify the presence of the user at the geographical user-location during inputting the plurality of hand-written inputs.

Preferably, the first device is a tablet computer.

Preferably, the geographical user-location is a medical office's postal address.

Preferably, the plurality of hand-written inputs comprise the user's first name, the user's last name, the user's date of birth, the user's time of arrival, the user's appointment time, the user's assigned doctor's name, and the user's signature.

Preferably, the second device is a desktop computer.

Preferably, the method further comprises converting the plurality of hand-written inputs into a plurality of text strings, via the server, and storing the plurality of text strings, via the server.

Preferably, the plurality of hand-written inputs are converted into text strings by utilizing at least one of an Optical Character Recognition (OCR) method, an Intelligent Word Recognition (IWR) method, and sensing the movements of the stylus or fingertip on the screen of the first device.

Preferably, the method further comprises generating authenticated documents comprising the hand-written inputs, via the server, wherein the authenticated documents are utilized in an audit for user's presence and user's information.

Preferably, a non-transitory machine-readable storage medium, which provides instructions that, when executed by a processing system, causes the processing system to perform operations according to the above method.

Preferably, a method of providing a graphical user interface, the graphical user interface being accessible via the first device, the second device, and the server said method comprising a method according to the above method.

Preferably, a non-transitory machine-readable storage medium, which provides instructions that, when executed by a processing system, causes the processing system to perform operations according to the above method.

In another aspect, a method of receiving presence and user information obtained within a geographical user-location is disclosed. The method comprises displaying a plurality of input regions on a screen of a first device, via the first device, receiving a plurality of hand-written inputs from a user, via the first device, said user utilizing a stylus or a fingertip to input the plurality of hand-written inputs in the plurality of input regions, receiving the geographical user-location, via the first device, transmitting the plurality of hand-written inputs and the geographical user-location, via the first device, removing the displayed plurality of hand-written inputs from the plurality of input regions, via the first device.

Preferably, a non-transitory machine-readable storage medium, which provides instructions that, when executed by a processing system, causes the processing system to perform operations according to the above method.

Preferably, a method of providing a graphical user interface, the graphical user interface being accessible via the first device said method comprising a method according to the above method.

In another aspect, a computer network system for receiving, storing, and authenticating presence and user information obtained within a geographical user-location is disclosed. The system comprises, a first device having a processing unit and program code stored on a storage device of said first device, said program code to perform a method when executed by said processing unit, said method, comprising displaying a plurality of input regions on a screen of the first device, receiving a plurality of hand-written inputs from a user, said user utilizing a stylus or a fingertip to input the plurality of hand-written inputs in the plurality of input regions, receiving the geographical user-location, transmitting the plurality of hand-written inputs and the geographical user-location, and removing the displayed plurality of hand-written inputs from the plurality of input regions, a server having a processing unit and program code stored on a storage device of said server, said program code to perform a method when executed by said processing unit, said method, comprising receiving the plurality of hand-written inputs and the geographical user-location, storing the plurality of hand-written inputs and the geographical user-location, associating the geographical user-location with the plurality of hand-written inputs from the user, and transmitting the plurality of hand-written inputs and the geographical user-location associated with the user, and a second device having a processing unit and program code stored on a storage device of said second device, said program code to perform a method when executed by said processing unit, said method, comprising receiving the plurality of hand-written inputs and the geographical user-location associated with the user, and in real time, consecutively displaying the plurality of hand-written inputs and the geographical user-location associated with the user on a screen of the second device, wherein the plurality of hand-written inputs, so associated with the user, may be utilized to authenticate that the plurality of the hand-written inputs were inputted by the user and to verify the presence of the user at the geographical user-location during inputting the plurality of hand-written inputs.

Preferably, the first device is a tablet computer.

Preferably, the geographical user-location is a medical office's postal address.

Preferably, the plurality of hand-written inputs comprise the user's first name, the user's last name, the user's date of birth, the user's time of arrival, the user's appointment time, the user's assigned doctor's name, and the user's signature.

Preferably, the second device is a desktop computer.

Preferably, the program code stored on the storage device of said server further comprises program code to perform a further method when executed by said processing unit, said further method, comprising converting the plurality of hand-written inputs into a plurality of text strings, and storing the plurality of text strings.

Preferably, the plurality of hand-written inputs are converted into text strings by utilizing at least one of an Optical Character Recognition (OCR) method, an Intelligent Word Recognition (IWR) method, and sensing the movements of the stylus or fingertip on the screen of the first device.

Preferably, the program code stored on the storage device of said server further comprises program code to perform a further method when executed by said processing unit, said further method, comprising generating authenticated documents comprising the hand-written inputs, wherein the authenticated documents are utilized in an audit for user's presence and user's information.

### DESCRIPTION OF THE DRAWINGS

FIG. 1A shows a schematic diagram of a preferred embodiment of a computer network system for implementing methods for receiving, storing, and authenticating presence and user information obtained within a geographical user-location in accordance with the present invention.

FIG. 1B shows a schematic diagram of the first device as shown in FIG. 1A, displaying a plurality of input regions where the user inputted his/her hand-written inputs in accordance with the present invention.

FIG. 1C shows a schematic diagram of a preferred embodiment of a list of the user's hand-written inputs converted into text string and the user's hand-written signature which may be stored on a server and/or displayed in real time on a display screen of a second device in accordance with the present invention.

FIG. 1D shows a schematic diagram of a preferred embodiment of a list of the user's hand-written inputs as it was inputted by the user without converting into text string and the user's hand-written signature which may be stored on a server and/or displayed in real time on a display screen of a second device in accordance with the present invention.

FIG. 2 shows a flow diagram of one preferred embodiment of a method of receiving, storing, and authenticating presence and user information obtained within a geographical user-location in accordance with the present invention.

FIG. 3 shows a flow diagram of one preferred embodiment of a method in addition to the method shown in FIG. 2 for converting hand-written inputs into text, storing them, and subsequently generating authenticated documents comprising the hand-written inputs in accordance with the present invention.

FIG. 4 shows a flow diagram of one preferred embodiment of a method of receiving presence and user information obtained within a geographical user-location in accordance with the present invention.

### DETAILED DESCRIPTION OF THE PRESENTLY PREFERRED EMBODIMENTS

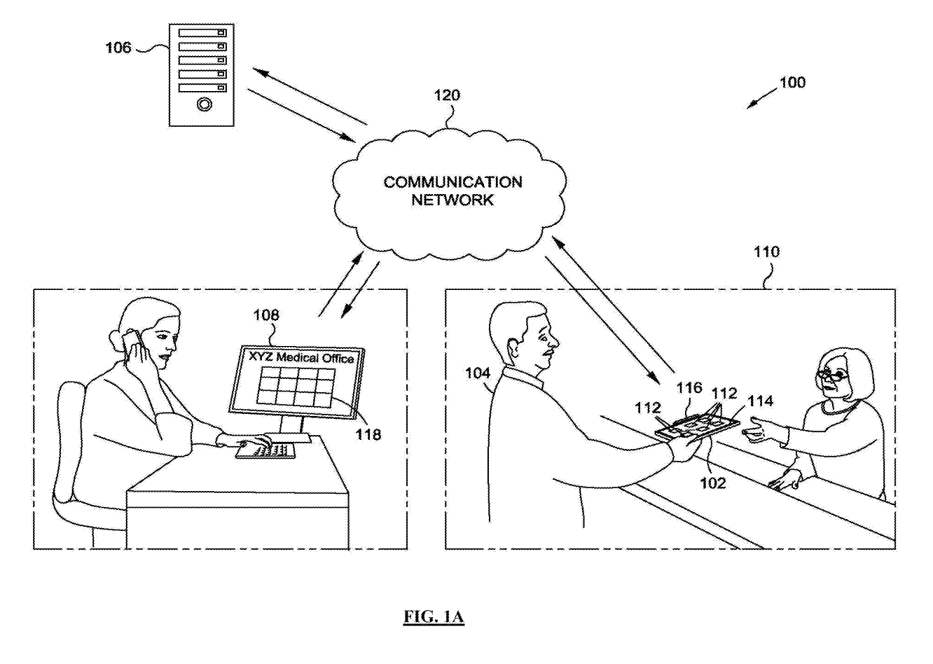

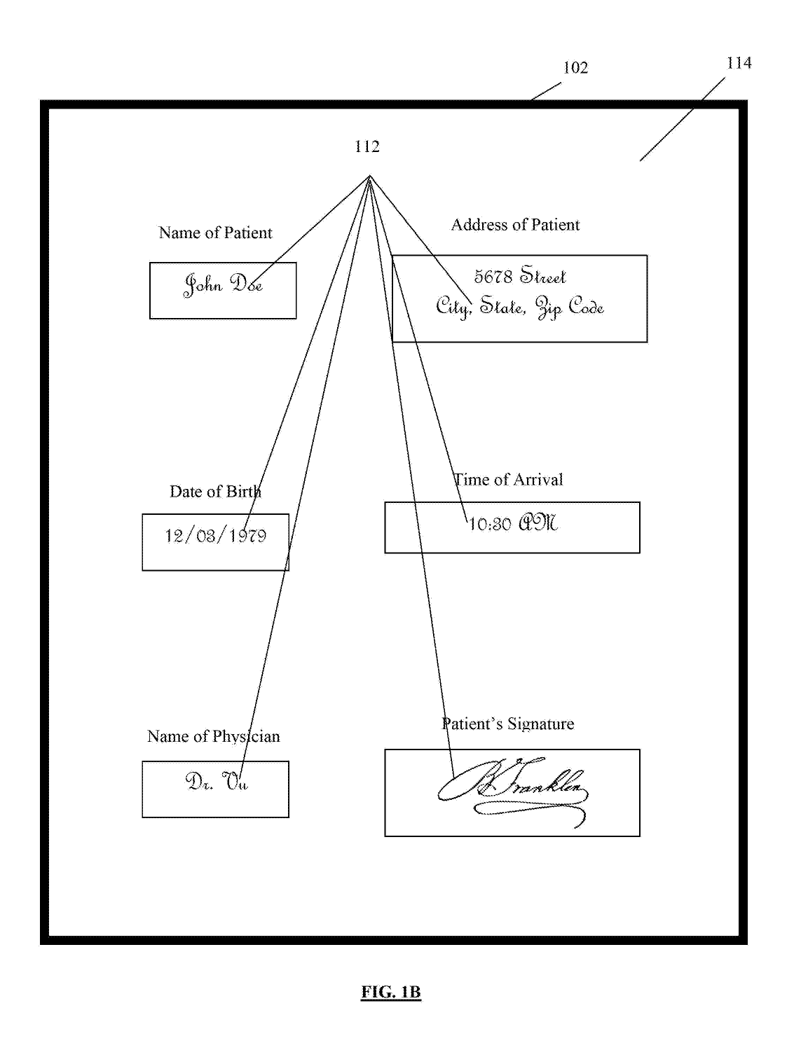

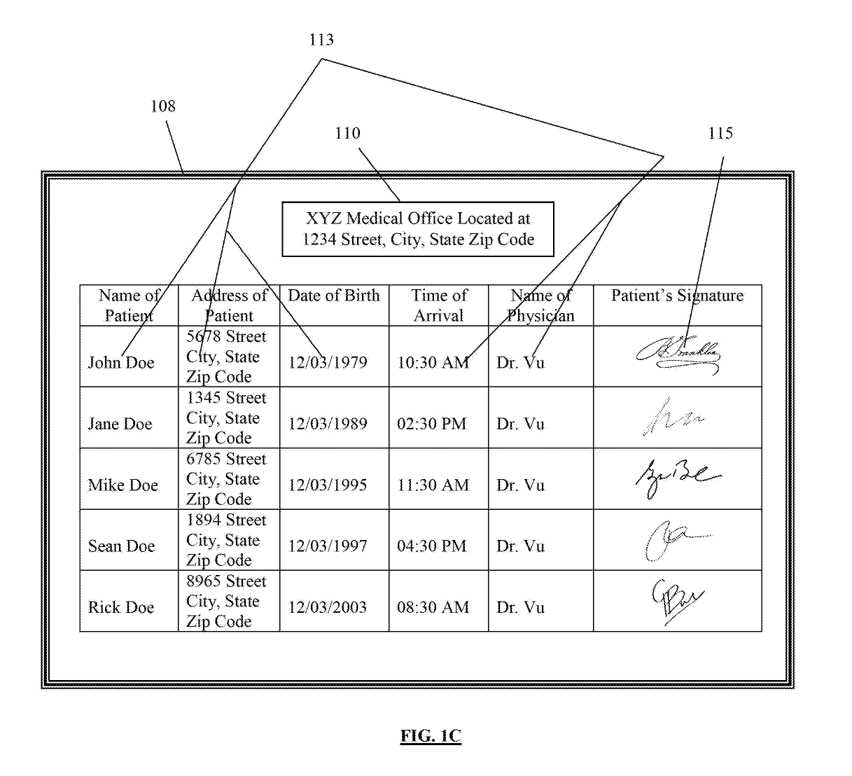

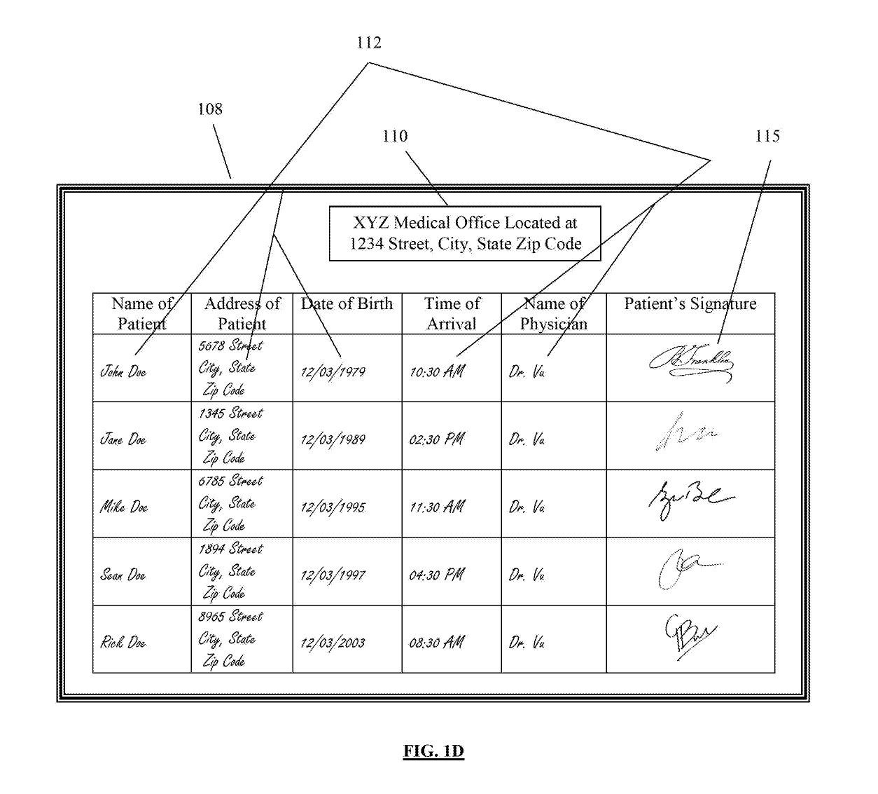

FIG. 1A depicts a schematic diagram 100 of a preferred embodiment of a computer network system for implementing methods for receiving, storing, and authenticating presence and user information obtained within a geographical user-location 110 in accordance with the present invention. In this embodiment, the geographical user-location 110 is a medical office. A user 104 (a patient) is given a first device 102 (tablet computer) and a stylus 116. The first device 102 displays a plurality of input regions on a screen 114 of the first device 102. The user 104 uses the stylus 116 to input and the first device 102 receives a plurality of hand-written inputs 112 from the user 104. The first device 102 is equipped with a GPS system where it receives the geographical location 110 where the user 104 is inputting his biometric inputs, i.e., the plurality of hand-written inputs 112, into the first device 102.

The first device 102 then transmits the plurality of hand-written inputs 112 and the geographical user-location 110 through the communication network 120 to a server 106. In one embodiment this transfer occurs in real time. In another embodiment, the first device 102 does this upon receiving a transmit command. After transmission, the first device 102 removes the displayed plurality of hand-written inputs 112 from the plurality of input regions and the first device 102 is available for a subsequent user to input her biometric inputs.

The server 106 receives the plurality of hand-written inputs 112 and the geographical user-location 110, stores then for future processing. The server 106 associates the geographical user-location 110 with the plurality of hand-written inputs 112 from the user 104. The server 106 transmits the plurality of hand-written inputs 112 and the geographical user-location 110 associated with the user 104 via the communication network 120.

A second device 108 (desktop computer) which may be at an entirely different geographical location such as in another city or state, receives the plurality of hand-written inputs 112 and the geographical user-location 110 associated with the user 104, and in real time, consecutively displays the plurality of hand-written inputs 112 and the geographical user-location 110 associated with the user 104 on a screen of the second device 108. The plurality of hand-written inputs 112, so associated with the user 104 are stored in a database in the server 106 and where they may be utilized to authenticate that the plurality of the hand-written inputs 112 were inputted by the user 104 and to verify the presence of the user 104 at the geographical user-location 110 during inputting the plurality of hand-written inputs 112.

FIG. 1B depicts a schematic diagram of the first device 102 as shown in FIG. 1A, displaying a plurality of input regions on the screen 114 of the first device 102 where the user inputted his/her hand-written inputs 112 in accordance with the present invention. The plurality of hand-written inputs 112 are biometric signals from the user 104 which can be utilized to authenticate the user 104 inputting the plurality of hand-written inputs 112. This manner of obtaining patient information which is obtained at a certain geographical location is not only compliant with the HIPPA rules, but it also prevents fraud and abuse. In addition, further analysis of the biometric inputs from the user 104 can be performed to obtain additional information about the user 104 at the time of entry such as his/her state of mind.

FIG. 1C shows a schematic diagram of a preferred embodiment of a list of user's hand-written inputs converted into text string 113 and the user's hand-written signature 115 component of the plurality of hand-written inputs 112, which may be stored on a server, such as the server 106 in FIG. 1A and/or displayed in real time on a display screen of a second device, such as the second device 108 in FIG. 1A in accordance with the present invention. In a preferred embodiment, the server 106 converts the plurality of hand-written inputs 112 into the plurality of text strings 113, utilizing the well-known OCR method. In another embodiment, the server 106 further generates authenticated documents comprising the text strings 113 including the signatures 115 component of the plurality of hand-written inputs 112. The authenticated documents can be used in an audit to verify the user's presence and authenticate the user as the individual who actually inputted the user's information.

FIG. 1D shows a schematic diagram of a preferred embodiment of a list of user's hand-written inputs as they were inputted 112 without converting them into text strings, which may be stored on a server, such as the server 106 in FIG. 1A and/or displayed in real time on a display screen of a second device, such as the second device 108 in FIG. 1A in accordance with the present invention. In a preferred embodiment, the server 106 further generates authenticated documents comprising the plurality of hand-written inputs 112. The authenticated documents can be used in an audit to verify the user's presence and authenticate the user as the individual who actually inputted the user's information.

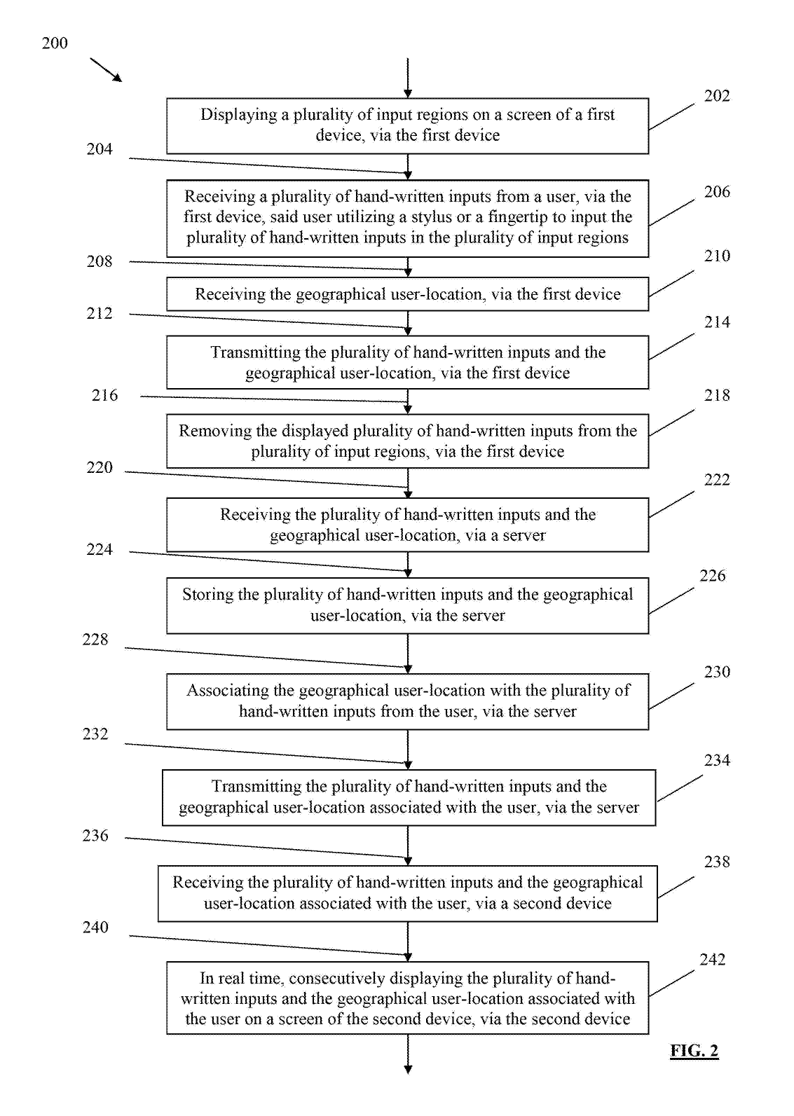

FIG. 2 shows a flow diagram 200 of one preferred method of receiving, storing, and authenticating presence and user information obtained within a geographical user-location in accordance with the present invention which may be implemented utilizing the computer network system 100 depicted in FIG. 1. According to this embodiment, the method comprises displaying a plurality of input regions on a screen 114 of a first device, such as the first device 102 at 202. The method further comprises receiving a plurality of hand-written inputs 112 from a user 104, via the first device 102 wherein the user 104 utilizes a stylus 116 or a fingertip to input the plurality of hand-written inputs 112 in the plurality of input regions displayed on the screen 114, at 206. The method further comprises receiving the geographical user-location 110, in this case the address of a medical office, via the first device 102, at 210. In this preferred embodiment, the first device 102 includes a GPS system which receives the geographical user-location 110 of the user 104. The method further comprises transmitting the plurality of hand-written inputs 112 and the geographical user-location 110, via the first device 102, at 214. The method further comprises removing the displayed plurality of hand-written inputs 112 from the plurality of input regions, via the first device 102, at 218, so that the device 102 can be used by another user to input his/her hand-written biometric signal onto the displayed plurality of input regions on the screen 114 of the first device 102.

The method further comprises receiving the plurality of hand-written inputs 112 and the geographical user-location 110, via a server 106, at 222. The method further comprises storing the plurality of hand-written inputs 112 and the geographical user-location 110, via the server 106, at 226. The method further comprises associating the geographical user-location 110 with the plurality of hand-written inputs 112 from the user 104, via the server 106, at 230. As such, the server 106 creates a list or a database of users, such as the user 104, who have inputted their plurality of hand-written biometric signals at the geographical user-location 110. The method further comprises transmitting the plurality of hand-written inputs 112 and the geographical user-location 110 associated with the user 104, via the server 106, at 234.

The method further comprises receiving the plurality of hand-written inputs 112 and the geographical user-location 110 associated with the user 104, via a second device 108, at 238. The method further comprises consecutively displaying the plurality of hand-written inputs 112 and the geographical user-location 110 associated with the user 104 on a screen 118 of the second device 108 in real time, at 242. As such, the plurality of hand-written inputs 112, so associated with users, such as the user 104, may be utilized to authenticate that the plurality of the hand-written inputs 112 were in fact inputted by the user 104 and to verify the presence of the user 104 at the geographical user-location 110 during inputting the plurality of hand-written inputs.

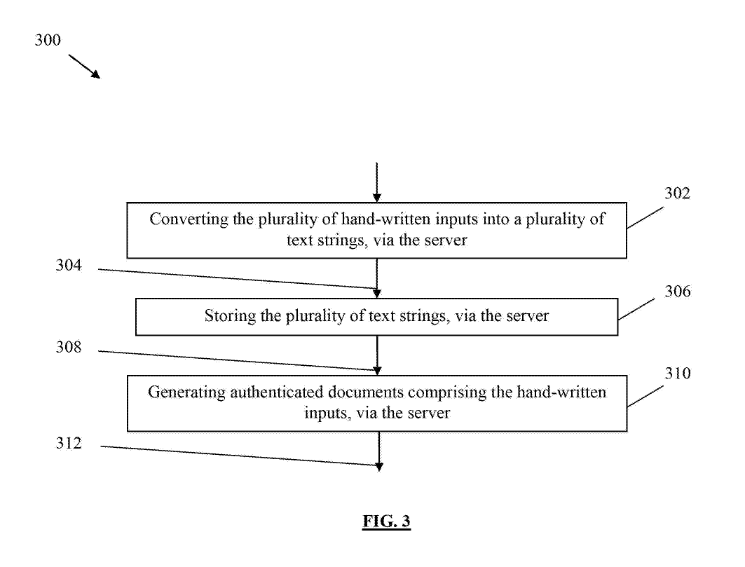

FIG. 3 shows a flow diagram 300 of one preferred embodiment of a method in addition to the method shown in FIG. 2 which may be implemented utilizing the computer network system depicted in FIGS. 1A, 1B, and 1C. This method further converts the hand-written inputs into text, stores them, and subsequently generates authenticated documents comprising the hand-written inputs in accordance with the present invention. According to this embodiment, the method comprises converting the plurality of hand-written inputs 112 into a plurality of text strings 113, via the server 106, at 302.

In a preferred embodiment, the plurality of hand-written inputs 112 are converted into text strings 113 by utilizing an Optical Character Recognition (OCR) method, known to artisans of ordinary skill. Other conversion methods, such as Intelligent Word Recognition (IWR) method, and the method of sensing the movements of the stylus or fingertip on the screen of the first device 102 may be utilized in other preferred embodiments.

The method further comprises storing the plurality of text strings 113 in the server 106, at 306. An authenticated database can thus be created by the server 106 which includes the geographical user-location and user biometric signals. The method further comprises generating authenticated documents comprising the hand-written inputs 112, at 310. The authenticated documents so created can be used for future audits such as those maintained by healthcare providers.

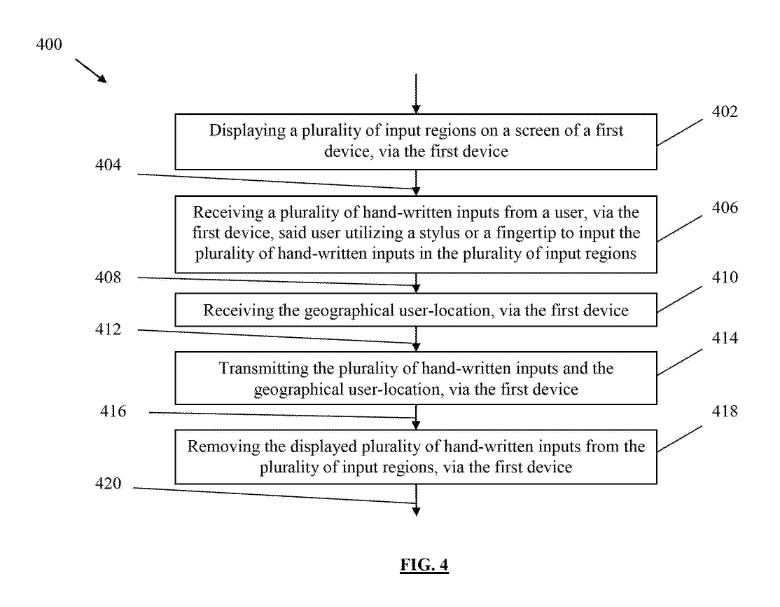

FIG. 4 shows a flow diagram of one preferred embodiment of a method of receiving presence and user information obtained within a geographical user-location in accordance with the present invention which may be implemented utilizing the first device 102 shown in FIG. 1. A graphical user interface (APP or Application Software) is ideal to implement the present method on a first device such as the Apple's iPad. According to this embodiment, the method comprises displaying a plurality of input regions on a screen 114 of the first device 102 at 402. The method further comprises receiving a plurality of hand-written inputs 112 from the user 104, via the first device 102 wherein the user 104 utilizes his fingertip to input the plurality of hand-written inputs 112 in the plurality of input regions, at 406. The method further comprises receiving the geographical user-location 110 via the GPS system of the first device 102, at 410. The method further comprises transmitting the plurality of hand-written inputs 112 and the geographical user-location 110, via the first device 102, at 414. The method further comprises removing the displayed plurality of hand-written inputs 112 from the plurality of input regions, via the first device 102, at 418, so that the first device 102 can be used by another user to input his/her hand-written biometric signal onto the displayed plurality of input regions.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A method of receiving, storing, and authenticating presence and user information obtained within a geographical user-location, said method comprising:
(i) displaying a plurality of input regions on a screen of a first device, via the first device;
(ii) receiving a plurality of hand-written inputs from a user, via the first device, said user utilizing a stylus or a fingertip to input the plurality of hand-written inputs in the plurality of input regions;
(iii) receiving the geographical user-location, via the first device;
(iv) transmitting the plurality of hand-written inputs and the geographical user-location, via the first device;
(v) removing the displayed plurality of hand-written inputs from the plurality of input regions, via the first device;
(vi) receiving the plurality of hand-written inputs and the geographical user-location, via a server;
(vii) storing the plurality of hand-written inputs and the geographical user-location, via the server;
(viii) associating the geographical user-location with the plurality of hand-written inputs from the user, via the server;
(ix) transmitting the plurality of hand-written inputs and the geographical user-location associated with the user, via the server;
(x) receiving the plurality of hand-written inputs and the geographical user-location associated with the user, via a second device; and
(xi) in real time, consecutively displaying the plurality of hand-written inputs and the geographical user-location associated with the user on a screen of the second device, via the second device;
wherein the plurality of hand-written inputs, so associated with the user, may be utilized to authenticate that the plurality of the hand-written inputs were inputted by the user and to verify the presence of the user at the geographical user-location during inputting the plurality of hand-written inputs.

2. The method of claim 1, wherein the first device is a tablet computer.

3. The method of claim 1, wherein the geographical user-location is a medical office's postal address.

4. The method of claim 1, wherein the plurality of hand-written inputs comprise the user's first name, the user's last name, the user's date of birth, the user's time of arrival, the user's appointment time, the user's assigned doctor's name, and the user's signature.

5. The method of claim 1, wherein the second device is a desktop computer.

6. The method of claim 1, further comprising:
(xii) converting the plurality of hand-written inputs into a plurality of text strings, via the server; and
(xiii) storing the plurality of text strings, via the server.

7. The method of claim 6, wherein the plurality of hand-written inputs are converted into text strings by utilizing at least one of an Optical Character Recognition (OCR) method, an Intelligent Word Recognition (IWR) method, and sensing the movements of the stylus or fingertip on the screen of the first device.

8. The method of claim 1, further comprising:
(xii) generating authenticated documents comprising the hand-written inputs, via the server;
wherein the authenticated documents are utilized in an audit for user's presence and user's information.

9. A non-transitory machine-readable storage medium, which provides instructions that, when executed by a processing system, causes the processing system to perform operations according to a method as in claim 1.

10. A method of providing a graphical user interface, the graphical user interface being accessible via the first device, the second device, and the server said method comprising a method as in claim 1.

11. A non-transitory machine-readable storage medium, which provides instructions that, when executed by a processing system, causes the processing system to perform operations according to a method as in claim 10.

12. A method of receiving presence and user information obtained within a geographical user-location, said method comprising:
(i) displaying a plurality of input regions on a screen of a first device, via the first device;
(ii) receiving a plurality of hand-written inputs from a user, via the first device, said user utilizing a stylus or a fingertip to input the plurality of hand-written inputs in the plurality of input regions;
(iii) receiving the geographical user-location, via the first device;
(iv) transmitting the plurality of hand-written inputs and the geographical user-location, via the first device; and
(v) removing the displayed plurality of hand-written inputs from the plurality of input regions, via the first device.

13. A non-transitory machine-readable storage medium, which provides instructions that, when executed by a processing system, causes the processing system to perform operations according to a method as in claim 12.

14. A method of providing a graphical user interface, the graphical user interface being accessible via the first device said method comprising a method as in claim 12.

15. A computer network system for receiving, storing, and authenticating presence and user information obtained within a geographical user-location, comprising:
(a) a first device having a processing unit and program code stored on a storage device of said first device, said program code to perform a method when executed by said processing unit, said method, comprising:
(i) displaying a plurality of input regions on a screen of the first device;
(ii) receiving a plurality of hand-written inputs from a user, said user utilizing a stylus or a fingertip to input the plurality of hand-written inputs in the plurality of input regions;
(iii) receiving the geographical user-location;
(iv) transmitting the plurality of hand-written inputs and the geographical user-location; and
(v) removing the displayed plurality of hand-written inputs from the plurality of input regions;
(b) a server having a processing unit and program code stored on a storage device of said server, said program code to perform a method when executed by said processing unit, said method, comprising:
(i) receiving the plurality of hand-written inputs and the geographical user-location;
(ii) storing the plurality of hand-written inputs and the geographical user-location;
(iii) associating the geographical user-location with the plurality of hand-written inputs from the user; and
(iv) transmitting the plurality of hand-written inputs and the geographical user-location associated with the user; and
(c) a second device having a processing unit and program code stored on a storage device of said second device, said program code to perform a method when executed by said processing unit, said method, comprising
(i) receiving the plurality of hand-written inputs and the geographical user-location associated with the user; and
(ii) in real time, consecutively displaying the plurality of hand-written inputs and the geographical user-location associated with the user on a screen of the second device;
wherein the plurality of hand-written inputs, so associated with the user, may be utilized to authenticate that the plurality of the hand-written inputs were inputted by the user and to verify the presence of the user at the geographical user-location during inputting the plurality of hand-written inputs.

16. The system of claim 15, wherein the first device is a tablet computer.

17. The system of claim 15, wherein the geographical user-location is a medical office's postal address.

18. The system of claim 15, wherein the plurality of hand-written inputs comprise the user's first name, the user's last name, the user's date of birth, the user's time of arrival, the user's appointment time, the user's assigned doctor's name, and the user's signature.

19. The system of claim 15, wherein the second device is a desktop computer.

20. The system of claim 15, wherein the program code stored on the storage device of said server further comprises program code to perform a further method when executed by said processing unit, said further method, comprising:
(iii) converting the plurality of hand-written inputs into a plurality of text strings; and
(iv) storing the plurality of text strings.

21. The system of claim 20, wherein the plurality of hand-written inputs are converted into text strings by utilizing at least one of an Optical Character Recognition (OCR) method, an Intelligent Word Recognition (IWR) method, and sensing the movements of the stylus or fingertip on the screen of the first device.

22. The system of claim 15, wherein the program code stored on the storage device of said server further comprises program code to perform a further method when executed by said processing unit, said further method, comprising:
(v) generating authenticated documents comprising the hand-written inputs;
wherein the authenticated documents are utilized in an audit for user's presence and user's information.
